(19) United States
(12) Patent Application Publication
(10) Pub. No.: US 2016/0012485 A1
(43) Pub. Date: Jan. 14, 2016

(54) BROWSING CONTEXT BASED ADVERTISEMENT SELECTION

(71) Applicant: Yahoo! Inc., Sunnyvale, CA (US)

(72) Inventors: Huali Dong, Beijing (CN); Weiru Zhang, Beijing (CN); Guangxin Yang, Beijing (CN); Hao Zheng, Beijing (CN); Huiting Liu, Beijing (CN); Li Rong, Beijing (CN)

(21) Appl. No.: 14/400,578

(22) PCT Filed: Jul. 8, 2014
(86) PCT No.: PCT/CN2014/081854

§ 371 Date: Nov. 12, 2014

(51) Int. Cl. G06Q 30/02

(52) U.S. Cl. CPC G06Q 30/0263; G06Q 30/0269

(57) ABSTRACT

A method for providing an advertisement is disclosed. The method, to be implemented on a machine having at least one processor, storage, and a communication platform connected to a network may include receiving a request for an advertisement to be inserted into a content page to be presented to a user. The method further includes selecting an advertisement relevant to the content page and the user based on a content-advertisement index and a user-advertisement index, constructed based on user browsing context, and transmitting information indicative of the selected advertisement as a response to the request. Further disclosed is a method for generating multi-dimensional index. The method, to be implemented on a machine having at least one processor, storage, and a communication platform connected to a network may include generating a content-advertisement index based on at least one content profile and at least one advertisement profile, and generating a user-advertisement index based on at least one user profile and the at least one advertisement profile. The content-advertisement index and the user-advertisement index are used to select a relevant advertisement to be inserted in a content page that is presented to a user.

### BACKGROUND

1. Technical Field

The present teaching relates generally to methods and systems for advertisements. Particularly, the present teaching is directed to methods and systems for selecting relevant advertisements to be presented to a user.

2. Discussion of Technical Background

In the world of display advertisements, users' interests are one of the most valuable signals that can be leveraged for selecting relevant ads. Because a user is most likely to act on advertisements that match his/her interests, an advertiser desires to reach out to people who are most interested in advertised products or services. To create a win-win-win situation, a publisher needs to display the most relevant ads to its users while serving content to the users.

Most existing techniques for targeted advertisement utilize information about user's past behaviors, such as page clicks and ad clicks, or rules that govern selection of ads based on locale information such as location, age, device, etc. However, other parameters may also provide useful information indicative of users' interests and can be utilized to select relevant advertisements.

### SUMMARY

The present teaching relates to methods, systems and programs for providing advertisement, specifically, for providing relevant advertisements based on users' browsing context.

In an embodiment, a method for providing an advertisement is disclosed. The method, to be implemented on a machine having at least one processor, storage, and a communication platform connected to a network may include receiving a request for an advertisement to be inserted into a content page to be presented to a user. The method further includes selecting an advertisement relevant to the content page and the user based on a content-advertisement index and a user-advertisement index, constructed based on user browsing context, and transmitting information indicative of the selected advertisement as a response to the request.

In an embodiment, a system for providing an advertisement is disclosed. The system includes at least one processor, storage, and a communication platform connected to a network. The system further includes a multi-dimensional index constructor configured for establishing a content-advertisement index and a user-advertisement index based on browsing context associated with users, and an online advertisement selector configured for selecting a relevant advertisement, based on the content-advertisement index and the user-advertisement index, in response to a request related to a content page into which the relevant advertisement is to be inserted and a user to whom the content page is to be presented.

In an embodiment, a non-transitory machine-readable medium having information recorded thereon for providing an advertisement is disclosed. The information, when read by the machine, causes the machine to receive a request for an advertisement to be inserted into a content page to be presented to a user. The information further causes the machine to select an advertisement relevant to the content page and the user based on a content-advertisement index and a user-advertisement index, constructed based on user browsing context, and transmit information indicative of the selected advertisement as a response to the request.

In an embodiment, a method for generating multi-dimensional index is disclosed. The method, to be implemented on a machine having at least one processor, storage, and a communication platform connected to a network may include generating a content-advertisement index based on at least one content profile and at least one advertisement profile, and generating a user-advertisement index based on at least one user profile and the at least one advertisement profile. The content-advertisement index and the user-advertisement index are used to select a relevant advertisement to be inserted in a content page that is presented to a user.

In an embodiment, a non-transitory machine-readable medium having information recorded thereon for generating multi-dimensional index. The information, when read by the machine, causes the machine to generate a content-advertisement index based on at least one content profile and at least one advertisement profile; and generate a user-advertisement index based on at least one user profile and the at least one advertisement profile. The content-advertisement index and the user-advertisement index are used to select a relevant advertisement to be inserted in a content page that is presented to a user.

In an embodiment, a multi-dimension index generator is disclosed. The multi-dimension index generator may include a content-ad index generator configured for generating a content-advertisement index based on at least one content profile and at least one advertisement profile, and a user-ad index generator configured for generating a user-advertisement index based on at least one user profile and the at least one advertisement profile. The content-advertisement index and the user-advertisement index are used to select a relevant advertisement to be inserted in a content page that is presented to a user.

### BRIEF DESCRIPTION OF DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts a high-level depiction of an exemplary system in which a browsing context based advertisement selector is deployed to provide advertisements, according to an embodiment of the present teaching;

FIG. 1A depicts a high-level depiction of an exemplary system in which a browsing context based advertisement selector is deployed to provide advertisements, according to a different embodiment of the present teaching;

FIG. 2 depicts a high-level exemplary system diagram of a browsing context based ad selector, according to an embodiment of the present teaching;

FIG. 3 depicts examples of a content-ad index and a user-ad index, according to an embodiment of the present teaching;

FIG. 4 depicts a high-level exemplary system diagram of a multi-dimensional index constructor, according to an embodiment of the present teaching;

FIG. 5 is a flowchart of an exemplary process for constructing the multi-dimensional indices, according to an embodiment of the present teaching;

FIG. 6 depicts examples of browsing context information, according to an embodiment of the present teaching;

FIG. 7 depicts examples of user actions performed while browsing, according to an embodiment of the present teaching;

FIG. 8 depicts examples of content related information, according to an embodiment of the present teaching;

FIG. 9 depicts examples of advertisement information, according to an embodiment of the present teaching;

FIG. 10 depicts a high-level exemplary system diagram of a content profile generator, according to an embodiment of the present teaching;

FIG. 11 depicts a high-level exemplary system diagram of an advertisement profile generator, according to an embodiment of the present teaching;

FIG. 12 depicts a high-level exemplary system diagram of a user profile generator, according to an embodiment of the present teaching;

FIG. 13 depicts a high-level exemplary system diagram of a content-ad index generator, according to an embodiment of the present teaching;

FIG. 14 is a flowchart of an exemplary process for generating a content-ad index, according to an embodiment of the present teaching;

FIG. 15 depicts a high-level exemplary system diagram of a user-ad index generator, according to an embodiment of the present teaching;

FIG. 16 is a flowchart of an exemplary process for generating a user-ad index, according to an embodiment of the present teaching;

FIG. 17 depicts a high-level exemplary system diagram of an online advertisement selector, according to an embodiment of the present teaching;

FIG. 18 is a flowchart of an exemplary process for selecting a relevant advertisement for display, according to an embodiment of the present teaching;

FIG. 19 depicts a general mobile device architecture on which the present teaching can be implemented; and

FIG. 20 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present teaching relates to methods and systems for advertisement. Particularly, the present teaching is directed to methods and systems for selecting relevant advertisements to be presented to a user.

One of the goals of advertisements is to sell a product and/or a service to users. The user is more likely to pay attention to, or interact with, an advertisement if the advertised product and/or service are of interest to the user. For example, a user interested in chess will be more likely to look at an advertisement for a book about chess strategies than a user interested in, e.g., soccer. Thus, one of the elements in presenting relevant advertisements to users is to decipher user interests.

In general, multiple methodologies can be, used for deciphering user interests. One of the ways is to use interest information provided by the users themselves. In many instances, users may provide a user profile to content providers that may include user interests. This user profile can be shared with, e.g., an advertisement selection engine to select advertisements that match the interests of the user. Another way is to decipher interests of users based on the history of products and/or services purchased by the users. Yet another way may be compiling a user profile based on the content that users accessed from content sources and the actions that the user performed on the content that the user is presented.

It should be noted that the terms “content provider” and “publisher” maybe used interchangeably herein and refer to an entity that provides or publishes electronic content to be accessed by users of a network. Content may include, for example, graphics, data, news, articles, software-based products, and so forth. A content provider may or may not provide the software used to access the content. A content provider may, in some instances refer to an entity that merely provides electronic content. In other instances, a content provider may refer to an entity that, alternatively or additionally, creates and/or distributes electronic content. Thus, in some instances, the term “publisher” may particularly refer to a content provider that provides content created by a third party for access by users. Examples of content providers include, but are not limited to, online news providers (e.g., The New York Times, The Wall Street Journal, Reuters, CNN, etc.), blogs (Tumblr, The Huffington Post, The Daily Beast, The Daily Caller, Tech Crunch, etc.), online game providers (e.g., Gaikai, OnLive, Playcast Media Systems, Zynga, etc.), massive online open courses (or MOOCs, e.g., Coursera, SlideRule, Khan Academy, Udemy, etc.), entertainment websites (e.g., ESPN, Hulu, Netflix, etc.), online database providers (e.g., IMDb, Wikipedia, etc.), content aggregators (e. g, Drudge Report, Squidoo, Slashdot, eHow, etc.), web portals (e.g., Yahoo!, Aol, Rediff, MSN, etc.), media hosting services (e.g., Youtube, Vimeo, GoFish, Veoh, etc.) and so forth.

Disclosed herein are methods and systems for selecting and providing relevant advertisements to users based on the users' browsing context. Browsing context, as used herein, refers to the content pages visited by users and/or their actions while viewing the content. Thus, browsing context includes time spent by a user reading or interacting with a content page and/or frequency with which the user visits the page. Actions of users while viewing content on the web include, but are not limited to, viewing the content for a period of time; sharing the content on social media or via communication methods such as email, instant message or text message; commenting on the content page (and the tone and/or content of the comments, e.g., positive or negative comments), printing a copy of the content page, scrolling through the content, revisiting the content, clicking (or, in case of touch-screen enabled devices, touching) links given in the content page, and so forth. The actions may be measured and/or quantified based on various metrics. For example, one method for quantifying a user's interaction with a content page is recording the time spent (i.e., dwell time) on the page. Given that users often open multiple pages and spend their time shifting back and forth between multiple pages, scrolling through and rate of scrolling through a page can provide a better quantification of a user's actual interest in the content of the page. As technology improves, other metrics of measuring user interaction with the page can be conceived. For example, in some smartphones, a user-facing camera can detect movement of pupils of the user to detect if a user is reading the content displayed on the screen of the smartphone. Data from such a pupil movement detection system can be used to measure user interaction. Similarly, in some embodiments, various sensors available on devices (including, but not limited to, cameras, microphones, accelerometers, and so forth) may be used to discern the expressions on the users' faces, or understand the context of sounds generated by the users while the users interact with the content. Such feedback may also be used in quantifying the users' interest levels in the content page(s). Other interactions and interaction metrics using presently available and/or yet to be developed technologies are contemplated.

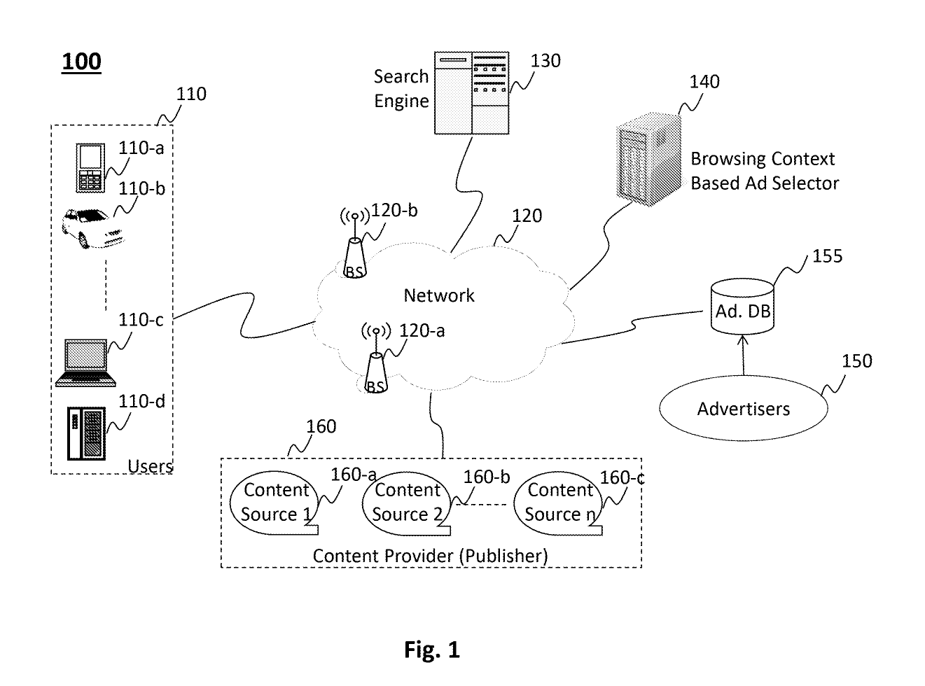

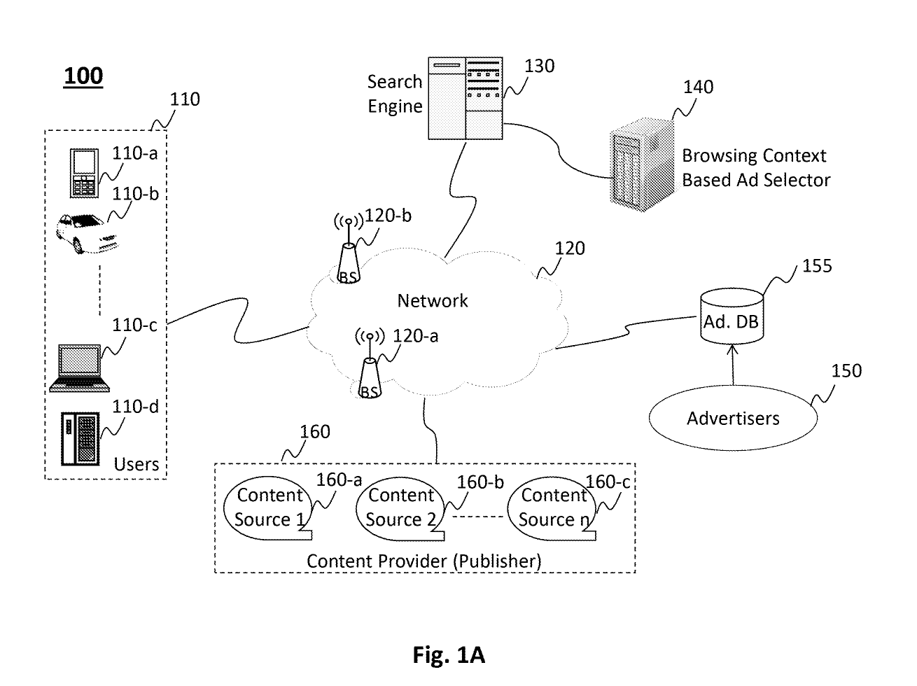

FIG. 1 depicts a high-level depiction of an exemplary system in which a browsing context based advertisement selector 140 is deployed to provide advertisements, according to a first embodiment of the present teaching. The exemplary system 100 includes user(s) 110, a network 120, a search engine 130, a browsing context based advertisement selector 140, content provider(s) 160 including content sources 160-a, 160-b, . . . , 160-c and so forth, and advertisements database(s) 155 provided by advertiser(s) 150, and an advertisement server 170. The network 120 can be a single network or a combination of different networks. For example, a network can be a local area network (LAN), a wide area network (WAN), a public network, a private network, a proprietary network, a public telephone switched network (PSTN), the internet, a wireless network, a virtual network or any combination thereof. A network may also include various network access points, e.g., wired or wireless access points such as base stations or internet exchange points 120-a, . . . , 120-b through with a user may connect to the network to access information via the network, and content providers and advertisers may connect to the network to transmit information via the network.

Users 110 may be of different types such as users connected to the network via desktop connections (110-d), users connecting to network 120 via wireless connections such as through a laptop (110-c), handheld device (110-a), or a built-in device in, for example, a motor vehicle (110-b), and so forth. Other types of users connecting to network 120 via other types of devices are contemplated. A user may send a query for a content via a search engine 130 via network 120 and receive a query result from search engine 130 via network 120 that may point the user to a content source, e.g., 160-a, provided by a publisher. In other instances, a user may choose to directly access content source, e.g., 160-b, provided by a publisher via network 120.

In order to monetize the provision of the content, publisher 160 may choose to include advertisements provided by, e.g., advertiser 150 and chosen from an advertisement database 155. Publisher 160 may, in some instances, get paid by advertisers 150 based on number of impressions (i.e., number of times an advertisement is shown or displayed by the content provider) and/or number of click-throughs associated with an advertisement. For example, a publisher may charge an advertiser $10 per thousand impressions and SI/click for an advertisement hosted by the publisher. While the publishers are interested in getting the maximum number of clicks for an advertisement displayed on their pages, advertisers are interested in converting their advertisements to a sale of product/service being advertised. Thus, displaying advertisements that will be more likely clicked (and interacted with) by the users is in the interest of the publisher as well as the advertiser. Browsing context based advertisement selector 140 can provide one of the ways for improving the click-through rate for advertisements displayed on a content page. As used herein, click-through rate for an advertisement refers to number of clicks divided by number impressions of an advertisement (e.g., clicks per 100 impressions).

In an example of the first embodiment as depicted in FIG. 1, browsing context based advertisement selector 140 is deployed as a stand-alone service provider which can provide services to either content provider 160 or the search engine 130 via network 120. When a user e.g., 110-a, queries search engine 130 for a piece of information via network 120, search engine 130 may result in a search result including a link to a content page from a content source, e.g., 160-a of content provider 160. The content page 160-a may be associated with a web page on which both content and advertisement are to be displayed. When user 110-a clicks content page 160-a, a request for an advertisement to be inserted into the web page may be sent to the browsing context based advertisement selector 140. With the request, information about user 110-a, the content page, and/or the information about the machine via which the user is requesting to access the content page may be incorporated therewith. Upon receiving the request for selecting relevant advertisements, information incorporated in the request about the user and the content page is analyzed by the browsing context based advertisement selector 140 and used in selecting one or more advertisements that are relevant to both the content page and the user's interests. Information related to the selected one or more advertisement is then provided to the content provider 160 or the search engine 130 via network 120. The selected one or more advertisements can then be retrieved, by the advertisement server 170 from the advertisement database 155, which may be populated by advertiser 150 or advertisement agencies (not shown), and displayed on the content page to the used through the advertisement server 170.

FIG. 1A depicts another embodiment of the network configuration, according to an embodiment of the present teaching. In this embodiment, the browsing context based advertisement selector 140 may be deployed as a back-end to a content provider (not shown) or the search engine 130 to select advertisements relevant to a content page that a user, e.g., 110-a, requests to view. If used as a backend of the search engine 130, when a user, e.g., 110-a, requests search engine 130 for viewing a content page via network 120, search engine 130 passes on information about the content page and user 110-a (e.g., using information such as, for example, user-identification, hardware identity or domain of machine being used to provide the query, location of the machine, history of queries received from the machine, etc.) to the backend browsing context based advertisement selector 140, The browsing context based advertisement selector 140 then analyze information related to the content page and the user in order to identify one or more advertisements to be inserted in the content page. The selection is then transmitted to the search engine 130, which then retrieves the actual advertisement from the advertisement database 155 through the advertisement server 170 and send to the browser of the user for display on the content page.

In a different embodiment, the browsing context based advertisement selector 140 may also be used as a backend module of the content provider (now shown), such as Yahoo!. In this case, when a user request the content provider 160 to serve a content page which has ad spots, the content provide 160 sends a request to its backend browsing context based advertisement selector 140 for identifying one or more advertisement that are relevant to both the content on the content page and the user who requests the content page. The identified advertisements are then retrieved by the content provider 160, insert into the content page, and displayed the content page with ads inserted to the user.

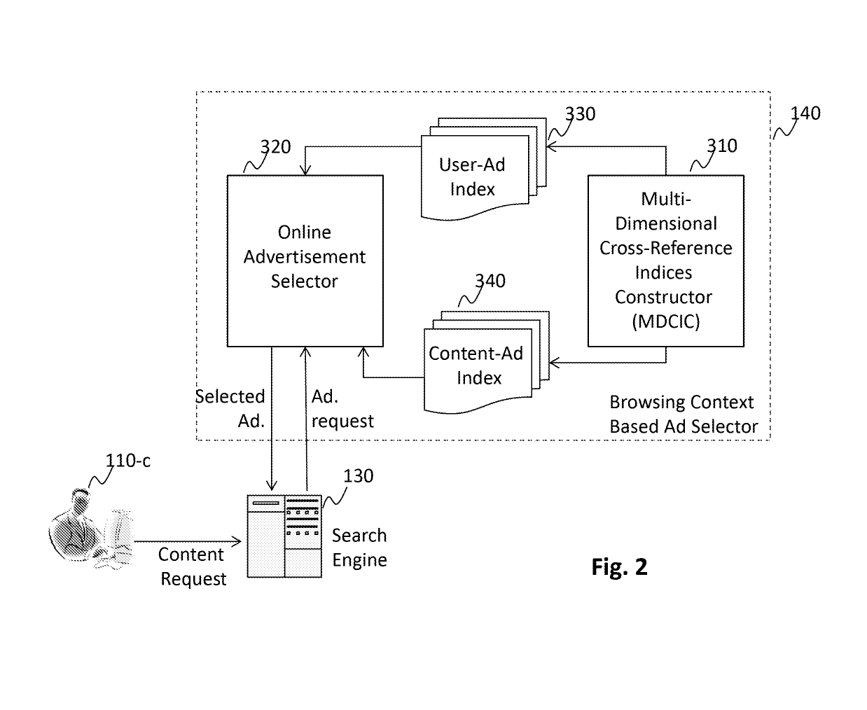

FIG. 2 depicts a high-level exemplary system diagram of browsing context based advertisement selector 140, according to an embodiment of the present teaching. Browsing context based advertisement selector 140 comprises an online advertisement selector 320, a user-ad index 330, a content-ad index 340, and a multi-dimensional index constructor (MDCIC) 310. When a user e.g., 110-c, requests a content page from, e.g., search engine 130, search engine 130 sends a request for advertisement(s) to online advertisement selector 320. Online advertisement selector 320 selects one or more advertisements based on the user-ad index 330 and content-ad index 340, and relays the selection back to search engine 130. Search engine 130 may then retrieve the advertisements based on the selection provided by online advertisement selector 320 and insert the advertisement into the content page that is to be delivered to user 110-c.

The selection of relevant advertisements is based on the content-ad index 340 and the user-ad index 330. MDCIC 310 is for constructing the user-ad index 330 and content-ad index 340 based on information related to various content pages, information about various users, and information related to various advertisements. The user-ad index 330 is provided to connect each user to various advertisements that are considered to be of interests to the user. The set of advertisements to be considered to be relevant to a user is determined based on both information that reflects or characterizes the interests of the user and information related to each advertisement. Information related to the interests of the user includes browsing context surrounding content browsed by the user. The content-ad index 340 is provided to connect each content page to various advertisements that are considered to be relevant to the content page. The set of advertisements to be considered to be relevant to a content page is determined based on both information characterizing the content page and information characterizing each advertisement. Examples of information related to a content page include keywords, topics, its popularity, and browsing context associated with it.

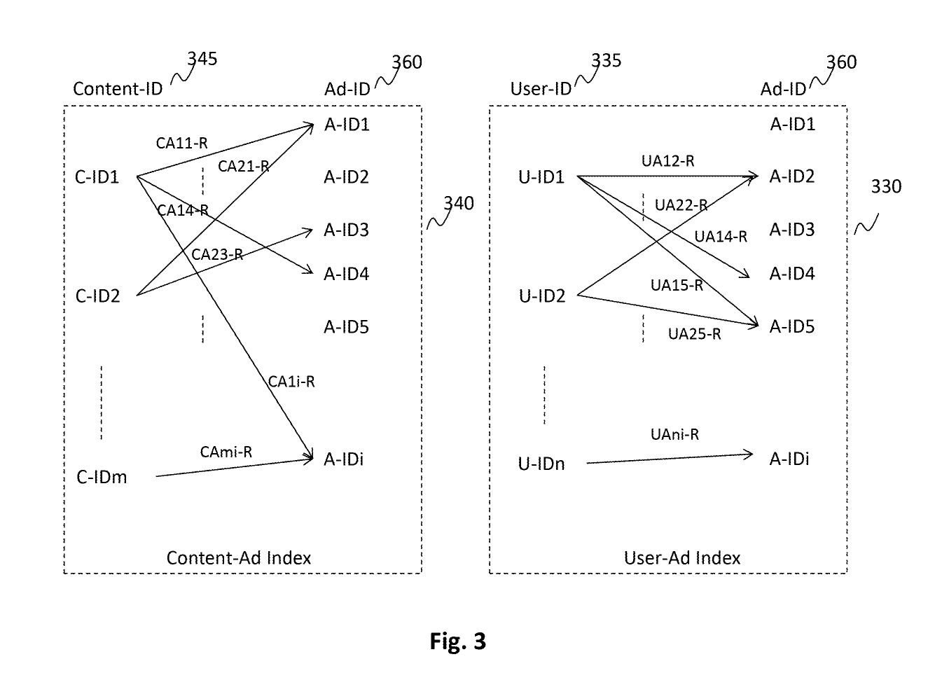

FIG. 3 depicts exemplary structure of content-ad index 340 and user-ad index 330, according to an embodiment of the present teaching. The content-ad index 340 is constructed to connect each content page with one or more advertisements that are considered relevant to the content page. The relevancy between a content page and an advertisement may be assessed based on variety types of information such as the content of the content page and/or popularity of the page. The user-ad index is constructed to connect each user with one or more advertisements that are considered relevant to the user or user's interests. The relevancy between a user and an advertisement may be assessed based on information related to user's interests and the nature of the advertisement.

An exemplary structure of the content-ad index 340 is shown in FIG. 3. To connect each content page with one or more advertisements, each instance of the content-ad index may include a content identifier, which is associated with a content page, and one or more advertisement identifiers associated with corresponding advertisements. The content-ad index in FIG. 3 illustrates that it has content identifiers 350 (C-ID1, C-ID2, . . . , C-IDm), each of which identifies a content page, e.g., provided by content provider 160. The content-ad index 340 also includes advertisement identifiers 360 (A-ID1, A-ID2, . . . , A-IDi), each of which identifies an advertisement, e.g., stored in advertisement database 155. As shown in FIG. 3, each content identifier is connected to one or more advertisement identifiers. The connection can be bi-directional (even though it is illustrated as one directional). For example, content identifier C-ID1 is connected to advertisement identifiers A-ID1, A-ID4, . . . , and A-IDj, signifying that advertisements identified by A-ID1, A-ID4, . . . , and A-IDj are relevant to a content page identified by content identifier C-ID1.

Each connection in the content-ad index is a pair ofidentifiers, with one content identifier and the other advertisement identifier. The degree of relevance of each advertisement to each content page may vary so that a relevant score may be used to specify the degree of relevance of each connection. For example, the pair (C-ID1, A-ID1) has a content-ad relevance score CA11-R. The pair (C-ID1, A-IDj) has a relevant score CA1j-R. The content-ad index 340 can be used in selecting advertisements relevant to a content page. For example, given a content page with a content identifier, advertisements relevant to the content page can be identified by selecting advertisements linked to the content identifier through the content-ad index 340. The most relevant advertisements may be selected based on the relevance score associated with the connections.

A similar exemplary structure for the user-ad index 330 is shown in FIG. 3. To index each user with one or more advertisements, each instance of the user-ad index may include a user identifier, which is associated with a user, and one or more advertisement identifiers associated with corresponding advertisements. The user-ad index in FIG. 3 illustrates that it has user identifiers 370 (U-ID1, U-ID2, . . . , U-IDp), each of which identifies a user. The user-ad index 330 also includes advertisement identifiers 360 (A-ID1, A-ID2, . . . , A-IDi), each of which identifies an advertisement, e.g., stored in advertisement database 155. Each user identifier is connected or indexed to one or more advertisement identifiers. The connection can be bi-directional (even though it is illustrated as one directional). For example, user identifier U-ID1 is connected to advertisement identifiers A-ID2, A-IDe, . . . , and A-IDj, signifying that advertisements identified by A-ID1, A-IDe, . . . , and A-IDj are relevant to user identified by user identifier U-ID1.

Each connection in the user-ad index is a pair of identifiers, with one user identifier and the other advertisement identifier. The degree of relevance of each advertisement to each user may vary so that a relevant score may be used to specify the degree of relevance of each connection. For example, pair (U-ID1, A-ID2) has a user-ad relevance score UA12-R. The pair (U-ID1, A-IDj) has a relevant score UA1j-R. The user-ad index 330 can be used in selecting advertisements relevant to a user. For example, given a user identifier for a user, advertisements relevant to the interests of the user can be identified by selecting advertisements linked to the user identifier through the user-ad index 330. The most relevant advertisements may be selected based on the relevance score associated with the connections.

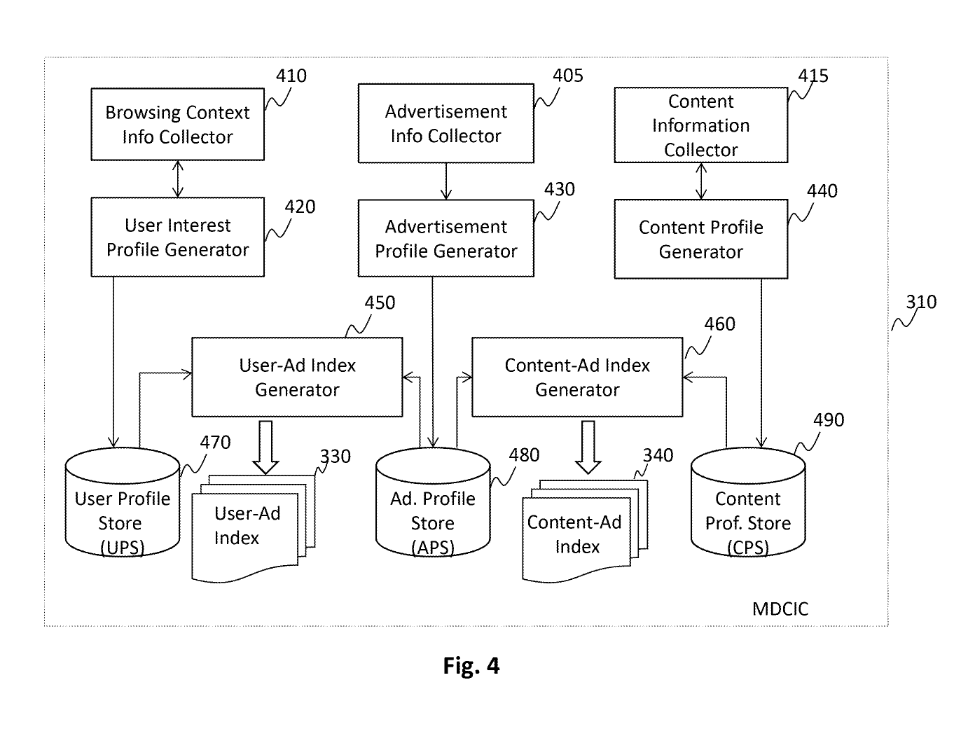

MDCIC 310 operates to construct the content-ad index 340 and user-ad index 330 and continuously update them based on information dynamically collected. FIG. 4 depicts an exemplary high level system diagram of MDCIC 310, according to an embodiment of the present teaching. In one embodiment, the MDCIC 310 comprises a user-ad index generator 450 responsible for generating the user-ad index 330 and content-ad index generator 460 responsible for generating the content-ad index 340. Other cross reference index can also be constructed based on the need of any particularly application context.

In some embodiments, the user-ad index generator 450 creates a user-ad index 330 based on user profiles from a user profile store 470 and advertisement profiles from an ad profile store 480. The content-ad index generator 460 creates the content-ad index 340 based on content profiles stored in a content profile store 490 and advertisement profiles stored in an advertisement profile store 480. User profile store 470 archives a user interest profile for each user, generated by user interest profile generator 420 based on information gathered by a browsing context information collector 405 and other user related information such as, for example, self-reported interest information.

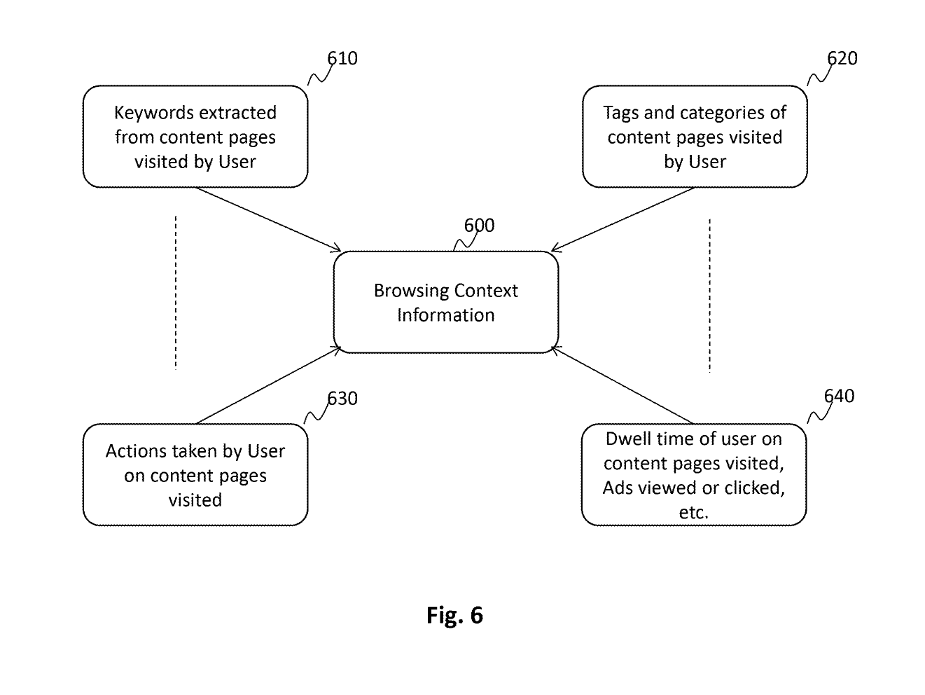

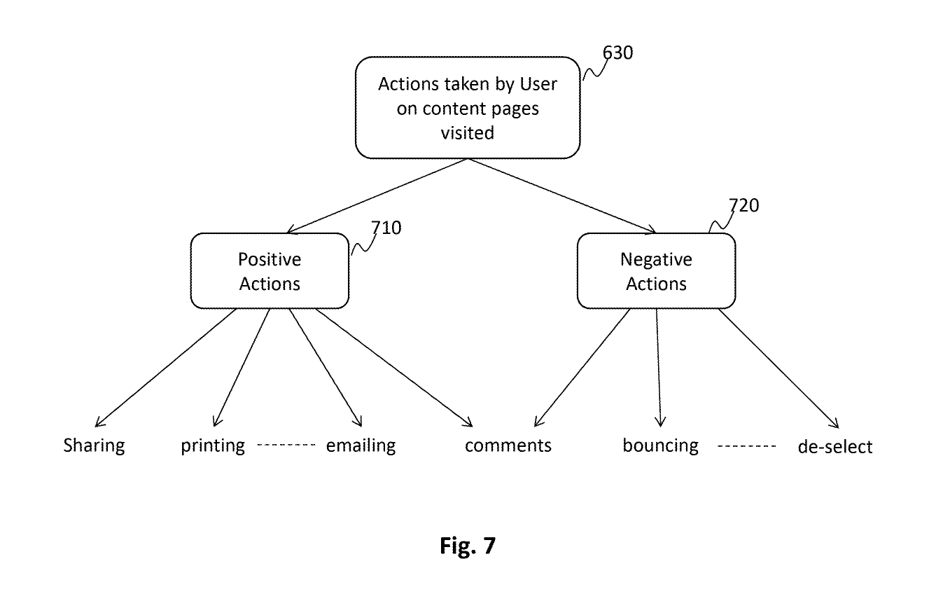

FIG. 6 depicts examples of browsing context information, according to an embodiment of the present teaching. Browsing context information 600 includes, but is not limited to, keywords (610) extracted from content pages visited by a user, actions of the user (630) performed on the content pages visited, tags and/or categories (620) of content pages visited by the user, dwell time of the user (640) associated with content pages and/or advertisements, etc. FIG. 7 illustrates some examples of actions 630 taken by the user on the content pages visited and/or advertisement viewed, which may include positive actions 710 as well as negative actions 720. Positive actions 710 include, for example, downloading, sharing, printing, emailing, positive commenting, and so forth. Negative actions 720 include, for example, bouncing, de-selecting, negative commenting, and so forth. Other information relating to browsing context is discussed in detail elsewhere herein.

For example, a user visiting and spending significant amounts of time reading about the movies such as, for example, “the Matrix”, “Speed”, “Constantine”, “Chain Reaction”, and so forth maybe considered to be interested in the actor Keanu Reeves based on the commonality between the content browsed by the user. The pages relating to each of these movies may include keywords relating to actors, directors, writers, producers of the movies; synopsis of the plot; trivia about the movies; and so forth. Such keywords are represented in 610. Likewise, if the user, while visiting content pages relating to these movies downloads photographs of actor Keanu Reeves, such actions are represented in 630. In many instances, a content publisher may include particular tags and categories with the content pages. For example, for the above mentioned movies, a publisher such as IMDB or Rotten Tomatoes may specifically include tags such as “Science Fiction”, “Keanu Reeves”, “Laurence Fishburne”, “Hugo Weaving”, “Sandra Bullock”, “Rachel Weiss”, and so forth. Such tags may be represented in 620. Additionally, some publishers may include advertisements with such pages. For example, a publisher may include links to trailers for movies such as “47 Ronin”, “Memento”, “Event Horizon”, “V for Vendetta”, (featuring one or more actors from the movie “the Matrix”) and so forth on a page for the movie “the Matrix”, or links to trailers for movies such as “Constantine”, “47 Ronin”, “Gravity”, “the Blind Side”, and so forth, (featuring one or more actors from the movie “Speed”) on a page for the movie “Speed”. A user may, in some instances, click and view such trailers. For example, a user interested in the actor Keanu Reeves may click on a link to a trailer for “47 Ronin” but ignore a link to a trailer for “Gravity”. Such information is represented in block 630.

Referring back to FIG. 4, the MDCIC 310 further includes a content profile generator 440 that create content profiles for content pages based on information related to content from a content information collector 415. The content profiles so created are stored in the content profile store 490.

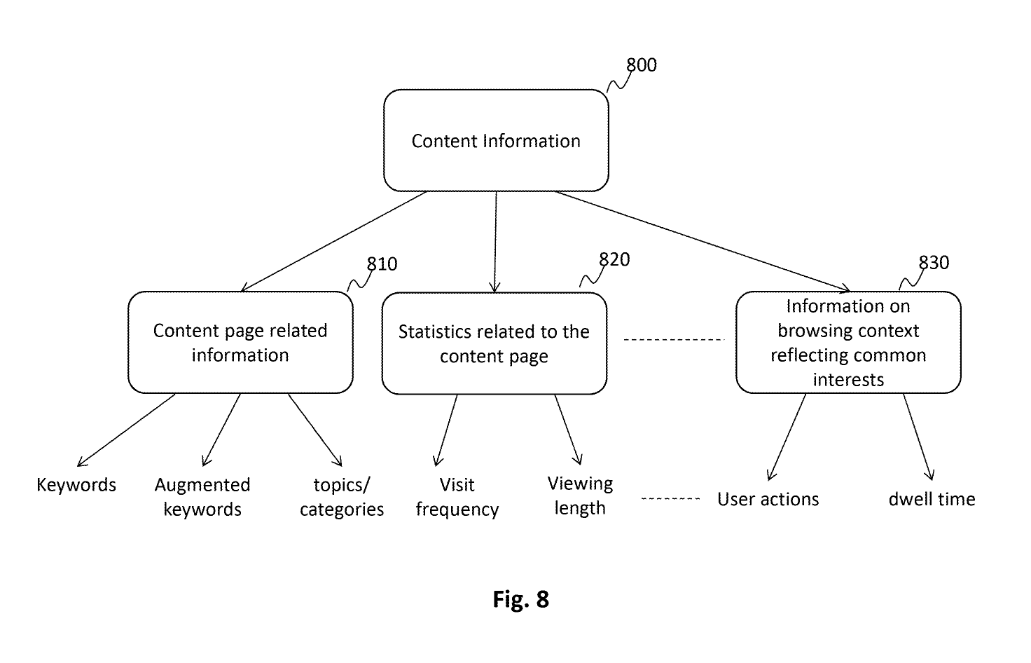

FIG. 8 depicts examples of content information that can be used in creating content profiles, according to an embodiment of the present teaching. Content information 800 includes, but is not limited to, content page related information 810 (e.g., keywords, augmented keywords, topics/categories, etc.), statistics related to the content page 820 (e.g., visit frequency, viewing length, etc.), information on browsing context (830) reflecting common interests of users (e.g., user actions, dwell time, scrolling speed, pauses during scrolling, etc.)

Keywords may come from different sources. For example, the content provider may supply them. In many situations, keywords are extracted from content pages by any party or process that analyzes the content, such as the content information collector 415. Keywords may be identified either offline or on-the-fly (as users visit the content page). Extracted keywords can be used to characterize individual content pages. For example, an article discussing a final score of a tennis match may include, as keywords, name of tournament during which the match was played (e.g., French Open), venue at which the tournament is taking place (e.g., Paris, France), names of the players involved (e.g., Rafael Nadal, Roger Federer), time stamp (e.g., date/day on which the match was played), and so forth. Extracted keywords may also be used to derive appropriate topics of the content page or classification into certain category of content.

Tags and/or categories associated with content may be useful, which can be either added by the content provider or automatically derived based on information extracted from the content or meta data of the content. Using the above example of the tennis match, categories may include, for example, sport (e. g., Tennis), tournament type (e.g., Grand Slam), subject of the page (e.g., scores), and so forth. In some embodiments, users may choose to add their own tags such as, for example, descriptors of the match (e.g., epic finale), nicknames of players (e.g., Rafa, Fedex), history of the match (e.g., who each of the players defeated in getting to the particular match), and so forth. Other examples of tags include, for example, “hashtags” used while sharing the page. In some embodiments, editors and/or content providers may choose to include, as tags, for example, frequently used words from comments on the page. In other embodiments, content information collector 415 may analyze a content page and classify the content page into some content category or content taxonomy. The number and length of such tags and categories may not be restricted in various embodiments. Other tags and categories are also contemplated. Such keywords, tags and categories are represented in 810.

Content related statistics 820 (i. e., statistics relating to users' visits) may also be used in a useful way to construct a content profile. For example, statistics of content page relating to the frequency of visits by users and users' interaction with the page may be used to infer the popularity of the page. In some embodiments, the statistics may include statistics about usage of particular words in comments (which may be, for example, algorithmically extracted). Other useful statistics are also contemplated.

Information reflecting the browsing context related to a content page may also be utilized to construct a content profile. For example, the number of times or frequency the page is requested viewed, dwell-time associated with each visit, number and/or frequency of user comments, number of times the page has been shared and/or emailed, number of re-visits by a same user, and so forth.

Referring back to FIG. 4, the MDCIC 310 also includes an advertisement profile generator 430 that creates advertisement profiles for advertisements and stored the created advertisement profiles in the advertisement profile store 480. The advertisement profile generator 430 generates an advertisement profile for an advertisement based on information surrounding the advertisement. Information about an advertisement may be gathered by an advertisement information collector 410 and may include information provided by an advertiser and/or its agent, or other information surrounding the advertisement such as, for example, user feedback about or popularity of the advertisement.

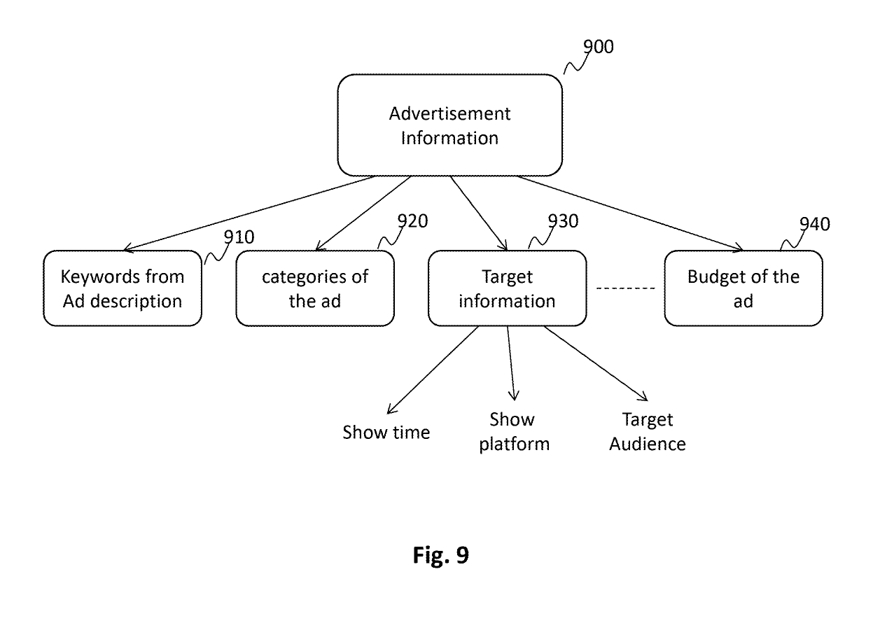

FIG. 9 depicts exemplary types of advertisement information that can be used in creating an advertisement profile, according to an embodiment of the present teaching. For example, advertisement information 900 includes keywords 910 from an advertisement description, categories of the advertisement 920, target information 930 (e.g., the intended or preferred delivery parameters related to the advertisement such as show time, show platform, target audience, etc.), budget of the advertisement 940 (e.g., financial or resource allocation), and so forth.

As can be seen, information about the browsing context is gathered dynamically and continuously, such information is used to dynamically update the user profiles and content profiles. In consequence, the user-ad index and the content-ad index are also updated dynamically to reflect the refined estimate of association between users and advertisement as well as between content and advertisements. For example, each time when a user views a content page and interacts with an advertisement displayed along with the content page, user activities and the browsing context are observed and used information available in the user-ad to update user profiles and content profiles. The updated content and user profiles then cause the user-ad index and content-ad index to be updated accordingly. With such dynamically adjusted profiles and indices, an advertisement given a particularly content page to be presented to a specific user can be selected using the updated user-ad index and content-ad index to maximize the relevance between the selected advertisement, the content page in which the selected advertisement is to be inserted, and the user to whom the content page with the selected advertisement is to be presented.

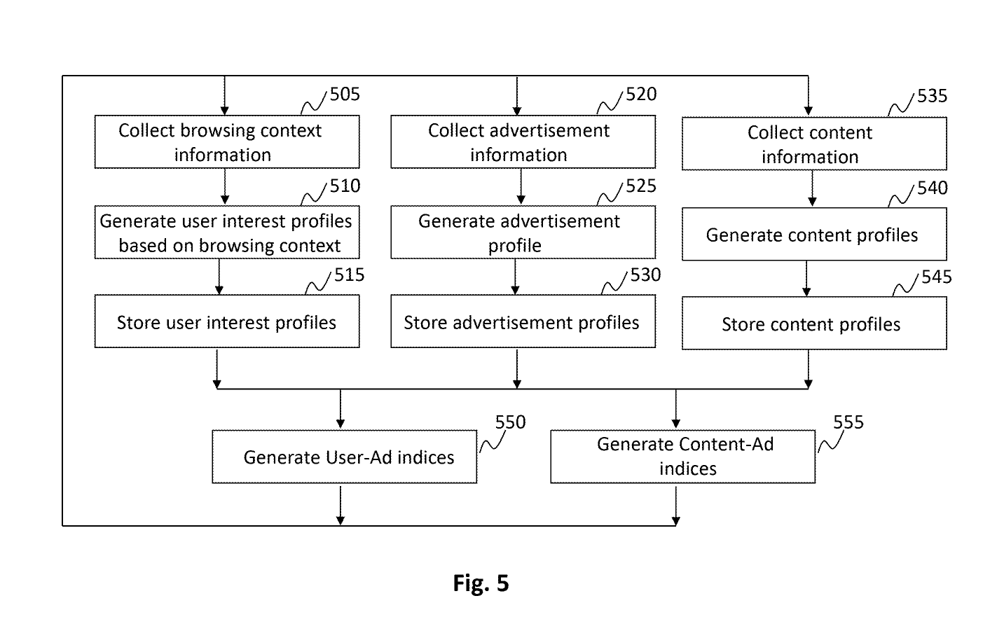

FIG. 5 depicts a flowchart of an exemplary process for constructing the multi-dimensional indices, according to an embodiment of the present teaching. At 505, browsing context information relating to each user is collected and the collection is dynamic and continuous. At 510, a user interest profile is generated for each user based on the gathered browsing context information as well as other information related to the user or user's interests. The created user interest profiles are then stored in user profile store at 515. At 520, information relating to advertisements is collected and used in generating, at 525, an advertisement profile for each available advertisement. The generated advertisement profiles are then stored in the advertisement profile store at 530. At 535, information relating to content is collected, which is used to generate a content profile for each content page at 540. At 545, content profiles generated for content pages are stored in the content profile store 490.

The user-ad index is constructed at 550 based on user profiles and advertisement profiles and stored (not shown). Similarly, the content-ad index is constructed at 555 based on content profiles and advertisement profiles and stored (not shown).

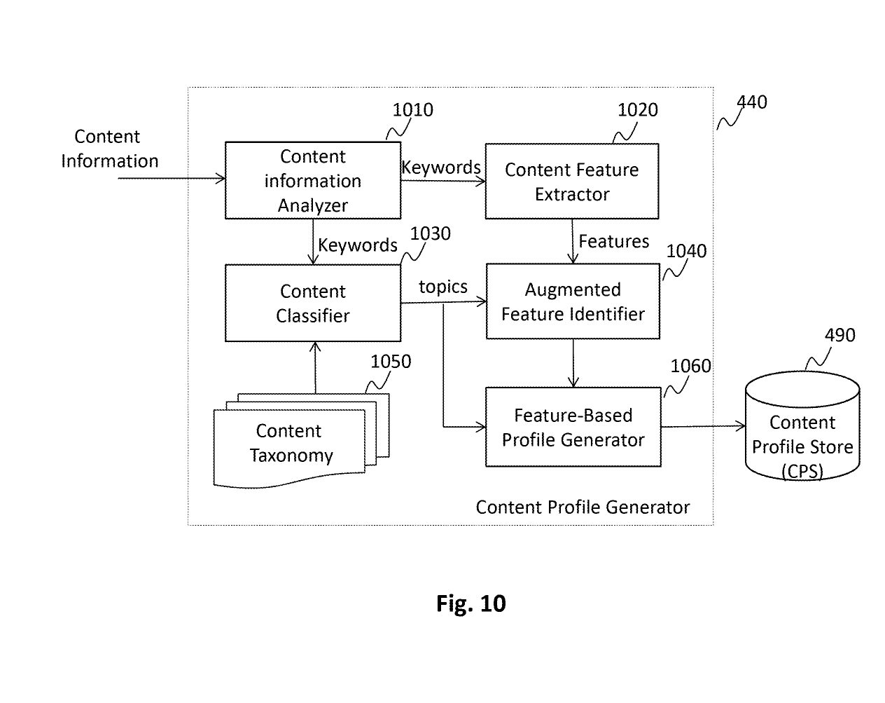

FIG. 10 depicts a high-level exemplary system diagram of the content profile generator 440, according to an embodiment of the present teaching. The content profile generator 440 comprises a content information analyzer 1010, a content classifier 1030, a content feature extractor 1020, an augmented feature identifier 1040 and a feature-based profile generator 1060.

The content information analyzer 1010 receives content related information (from the content information collector 415) to identify various content related features. Content related information may include the content page itself. In some embodiments, keywords are extracted by the content information analyzer 1010 from the content page. As discussed, in some embodiments, keywords from the content page may also be supplied by, e.g., a content creator, a publisher and/or editor of the content, or some third party service provider. In some embodiments, keywords may also be provided by users visiting the content page. In addition to keywords, other features may also be identified from a content page. For example, frequencies of occurrences of keywords can also be identified.

Based on the content features, such as keywords, the content classifier 1030 may classify the content page into one or more topics in accordance with, e.g., content taxonomy 1050. For example, a content page with keywords tennis, tournament, etc. may be classified as related to “sports.” As another example, in the tennis article example discussed above, the article may be classified to relate to topic “Sports commentator.” The identified keywords and the classified topics of the content page may then be sent to the augmented feature identifier 1040.

The augmented feature identifier 1040 may be deployed to expand the features related to a content page based on known keywords from a content page as well as estimated topics of the content page. For example, if keywords “tennis” and “tournament” are extracted and the content page is classified as related to “sports”, additional keywords may be extracted from the content page as augmented features that provide further information related to the event described in the content page. For instance, names of people involved in the tournament, the name of the geographic location where the tournament is held, and the date of the event may be identified so that the content page may be better represented based on the keywords and the augmented keywords.

The feature-based profile extractor 1060 then generate a content profile for a content page based on information related to the content, including keywords, topics, and augmented features. In some embodiments, a content profile for a content page may correspond to a high dimensional feature vector with attributes describing various features associated with the content page. Such a created content profile is then stored in content profile store 490.

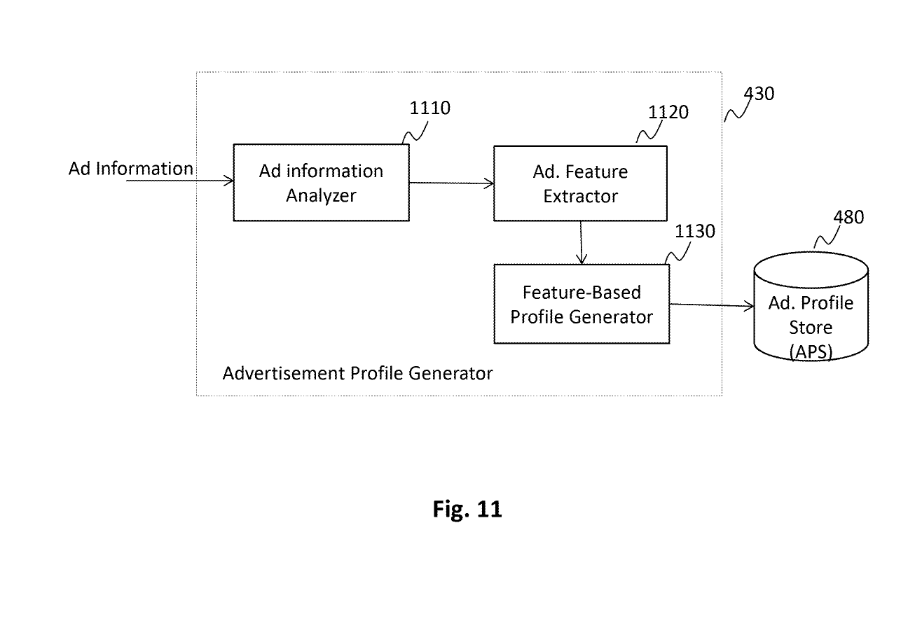

FIG. 11 depicts a high-level exemplary system diagram of the advertisement profile generator 430, according to an embodiment of the present teaching. The advertisement profile generator 430 comprises an advertisement information analyzer 1110, an advertisement feature extractor 1120 and a feature-based advertisement profile generator 1130. The advertisement information analyzer 1110 receives advertisement related information related to an advertisement from advertisement information collector 405, and analyzes the advertisement related information to extract various features associated with the advertisement. Such features include words used to describe the advertisement or words in the advertisement itself, including, e.g., class or category of product/service being advertised. Advertisement related information may also include information related to parameters related to the intended or desired delivery of the advertisement. For example, there may be specified intended demographics of the target audience (e.g., professionals over 35), preferred display platform (e.g., mobile or TV), desired display format (e.g., video rather than still images), etc. The advertisement feature extractor 1120 extracts useful features related to the advertisement and sends the extracted features to the feature-based advertisement profile generator 1130, which in turn creates an advertisement profile incorporating important features related to the advertisement. The created advertisement profile is then stored in the advertisement-profile store 480.

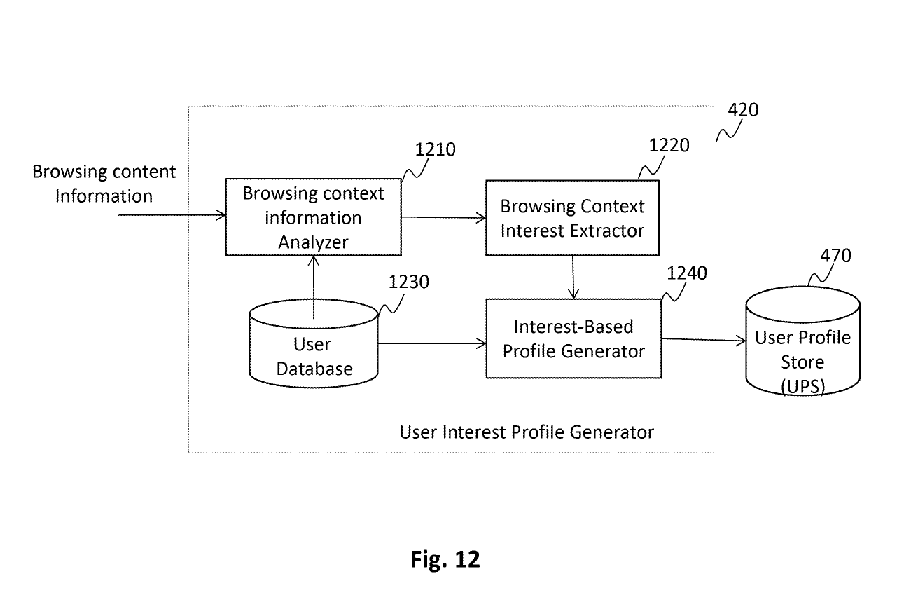

FIG. 12 depicts a high-level exemplary system diagram of the user interest profile generator 420, according to an embodiment of the present teaching. The user interest profile generator 420 comprises a user database 1230, a browsing context information analyzer 1210, a browsing context feature extractor 1220, and a feature-based user interest profile generator 1240. The user database 1230 stores information about users including, but not limited to, personal information, social connections, browsing history and/or habits, self-reported interests, estimated interests, etc. Browsing context information analyzer 1210 receives information from browsing context information collector 405 and cross-references this information with information from user database 1230 to analyze browsing context information associated with a user and send the analyzed information to the browsing context feature extractor 1220. The browsing context information analyzer 1210 may group observed browsing context information into different categories, e.g., recognizing positive and negative actions observed from a user and associating each observed action with certain content which may be characterized into topics.

Upon receiving analyzed browsing context information, the browsing context feature extractor 1220 estimate features that can be used to characterize the user's estimated interests. For example, the browsing context feature extractor 1220 may estimate the relative levels of interests of the user against a plurality of pre-defined categories of interests. As can be seen, the estimated levels of interests of the user are consistent with the observed user behavior as well as self-reported interests. Such estimated features of the user are then sent to the feature-based user interest profile generator 1240, which in turn generates a user profile and stored the created profile in the user profile store 470.

In generating profiles for content, advertisements, or a user, if a prior profile already exists in a corresponding profile store, the pre-existing profile is updated based on the newly collected information. In this way, the profiles for content, user, and advertisement can be made adaptive.

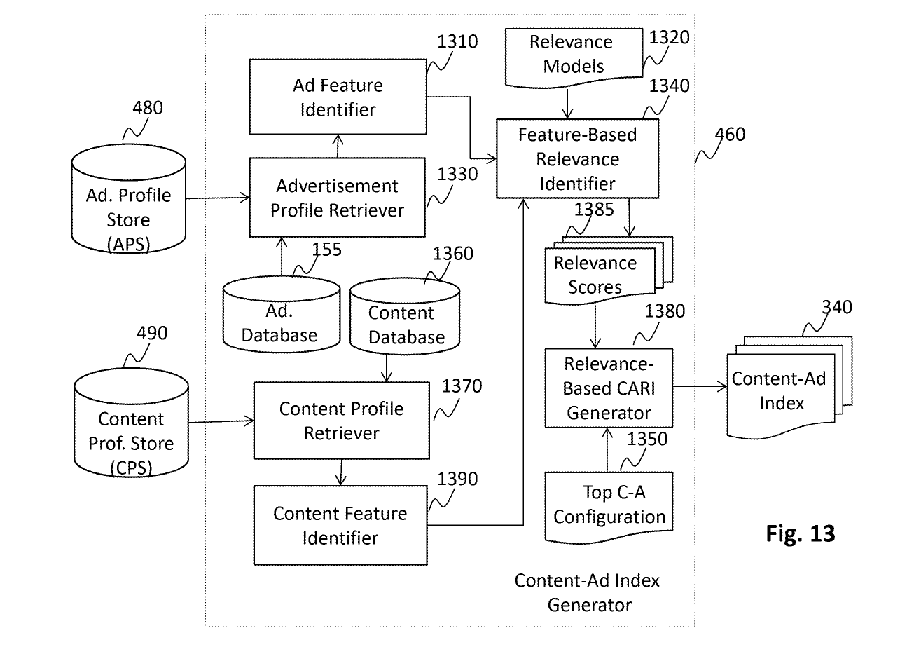

FIG. 13 depicts a high-level exemplary system diagram of the content-ad index generator 460, according to an embodiment of the present teaching. The content-ad index generator 460 uses information from advertisement profile store 480 and content profile store 490 to generate content-ad index 340. The content-ad index generator 460 includes a content profile retriever 1370, a content feature identifier 1390, an advertisement profile retriever 1330, an ad feature identifier 1310, a feature-based relevance identifier 1340, and a relevance based content-ad relevance index (CARI) generator 1380.

To build content-ad index 340, the content profile retriever 1370 retrieves, for each piece of content such as a content page stored in content database 1360, a content profile for the content page from content profile store 490. Based on the retrieved content profile, the content feature identifier 1390 identifies features from the content profile that are to be used to determine its relevance with various advertisements. To estimate the relevance between the content page and each specific advertisement, the advertisement profile retriever 1330 retrieves an advertisement profile for each advertisement archived in the advertisement database 155. An ad feature identifier 1310 then identifies particular features from each advertisement profile that are to be used in determining the relevance between the advertisement and a content page. The feature-based relevance identifier 1340 then computes a relevance score for each advertisement with respect to the content page based on their respective features identified from their corresponding profiles. Such computed relevance scores are then stored in a C-A (content-ad) relevance score archive 1385.

A C-A relevance score estimated based on two sets of features (one for the content page and one for the advertisement) can be computed using any models known in the art. Any model can be configured and stored in 1320 and used by the feature-based relevance identifier 1340. Exemplary models include a model using Euclidian distance between two feature sets or a model that computes the similarity between two feature vectors. Each pair of a content page and an advertisement is described by a value of a relevance score representing a degree of relevance between a content page and ad advertisement. This is shown in FIG. 3, e.g., relevance score CA11-R, denoting the relevance score between the first content page and the first advertisement, and CAmi-R, denoting the relevance score between the mth content page and the ith advertisement.

In some embodiments, a relevance score can be estimated by computing the cosine between the advertisement feature vector and the content feature vector. In other embodiments, machine learning can be deployed to learn a model for computing the relevance score. For example, based on past data, a learning algorithm, such as logistic regression or neural networks, may be used for learning a model to be used to compute relevance scores. In such embodiments, the computed C-A relevance scores can be adaptively enhanced based on data continuously gathered. For example, after a relevance score is computed and stored, e.g., CA2i-R, when more information, e.g., related to the browsing context of the corresponding content page (2^{nd} content page) with the corresponding advertisement displayed therein (the ith advertisement), is available, the additional information may be used to update the content profile which then causes the relevance score CA2i-R being updated based on the updated content profile.

The C-A relevance score archive 1385 provides relevance scores for every pair of content page and advertisement. In operation, to ensure efficiency, for each content page, there may be only a portion of the advertisements with high enough relevance scores are considered for selection. For that purpose, for each content page, its relevance scores with respect to the advertisements available can be ranked so that only a certain number of advertisements that have top ranking scores are considered to be relevant to the content page. The relevance-based CARI generator 1380 generates a content-ad index 340 for every content page available in content database 1360 by linking each content page with a specified (e.g., K) number of top ranking advertisements, determined based on their respective relevance scores (stored as top C-A configuration 1350). This is shown in FIG. 3.

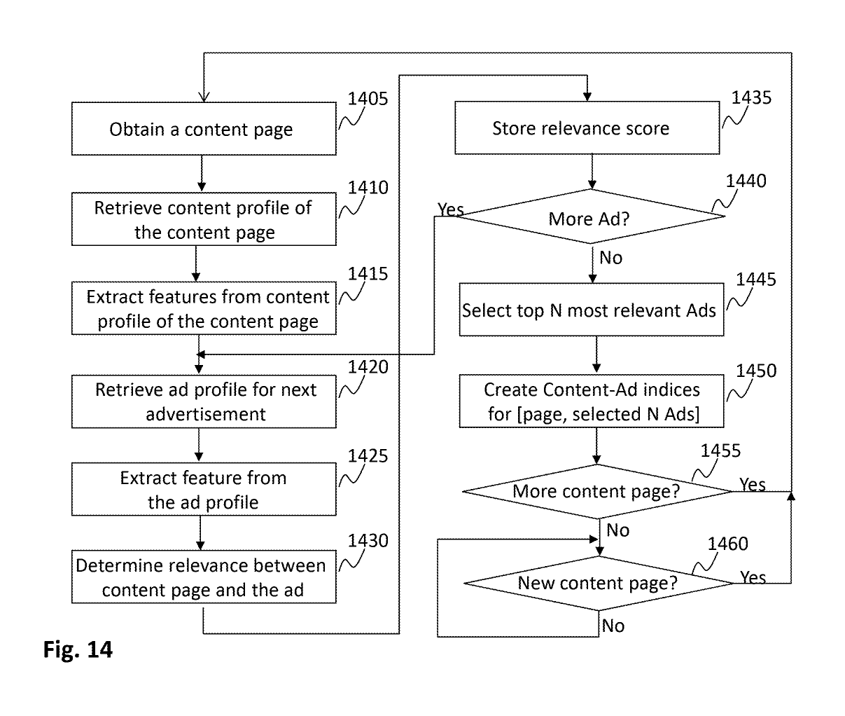

FIG. 14 is a flowchart of an exemplary process for generating content-ad index 340, according to an embodiment of the present teaching. At 1405, a content page is obtained. At 1410 content profile for the content page is retrieved. At 1415 content features from the content profile of the content page are identified. At 1420, an advertisement profile for an advertisement (e.g., obtained from advertisement database 155) is retrieved followed by identification, at 1425, of advertisement features from the advertisement profile. At 1430, a relevance score between the content page and the advertisement is computed based on the identified content features and advertisement features. At 1435, the relevance score is stored (e.g., in relevance score database 1385).

At 1440, it is checked to see whether there are remaining advertisements (e.g., in advertisement database 155) that have not been processed with respect to the current content page. If yes, the process goes back to 1420 to retrieve the next advertisement profile for the next advertisement and continues till the relevance scores for all advertisements stored in the advertisement database 155 are determined and stored. Once relevance scores between the current content page and the advertisements are determined (No, following 1440), top N most relevant advertisements are selected at 1445 based on the relevance scores with respect to the content page. At 1450, content-ad index 340 is created for the particular content page based on the N most relevant advertisements with respect to the current content page. Example structure of such an index for a specific content page is shown in FIG. 3. At 1455, it is determined whether there is any additional content page. If there are additional content pages for which no content-ad index has been established, the process returns to 1405 to access the next content page for identifying N top most relevant advertisements. The process continues until all content pages have been so processed. If the determination at 1455 is no, the process waits till a new content page is available. If (or when) a new content page is available, the process returns to 1405 and proceeds to build the content-ad index for the newly available content page. One of ordinary skill in the art will recognize that while the flow chart in FIG. 14 shows a sequential process, content pages may be processed in parallel to create content-ad index 340.

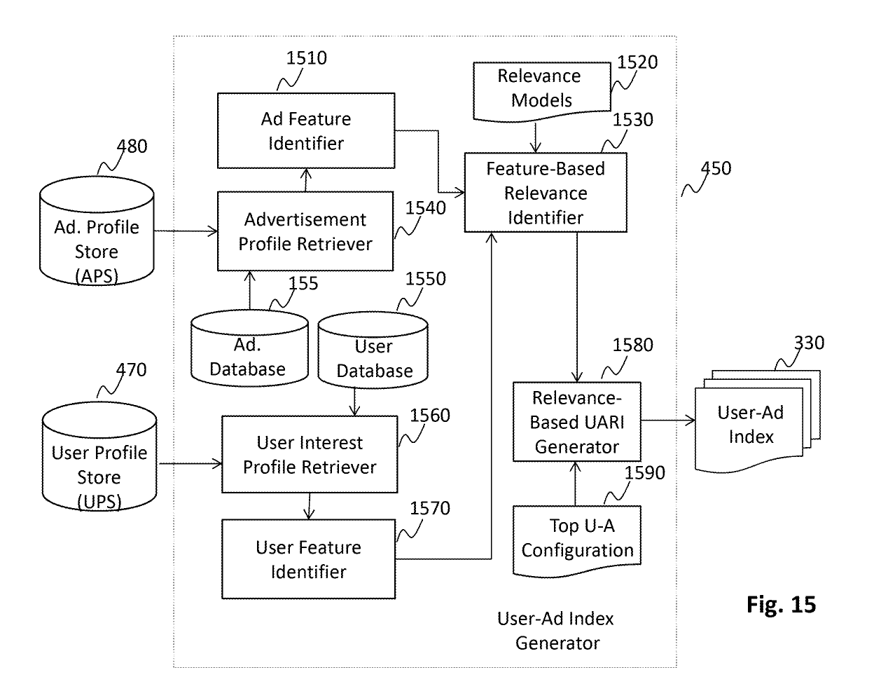

FIG. 15 depicts a high-level exemplary system diagram of the user-ad index generator 450, according to an embodiment of the present teaching. The user-ad index generator 450 creates the user-ad index 330 based on advertisement profiles from the advertisement profile store 480 and user profiles from the user profile store 470. The user-ad index generator 450 includes a user profile retriever 1560, a user feature identifier 1570, an ad profile retriever 1540, an ad feature identifier 1510, a feature-based relevance identifier 1530, and a relevance based user-ad relevance index (UARI) generator 1380.

To construct the user-ad index 330, for each user in a user database 1550, the user profile retriever 1560 retrieves a user profile for that user from user profile store 470. The user feature identifier 1570 then identifies features from the user profile that are to be used to assess the relevance between the user and an advertisement. As discussed above, a user profile may include various information that characterize the user's, e.g., demographics or interests such as topics of interests. For each user, the advertisement profile retriever 1540 retrieves an advertisement profile for each of the advertisements stored in the advertisement database 155. The ad feature identifier 1510 then identifies features of the advertisement from the advertisement profile in order to assess the relevance between the user and the advertisement. Based on the features of the user and that of the advertisement, the feature-based relevance identifier 1530 estimates a U-A relevance score in accordance with a model selected from relevance models archive 1520. The relevance models can be any known in the art. The system may configure to use a specific model depending on the needs or requirements of the underlying application. The models archived may also include parameters to be used in each model so that when the model is deployed in an application, the parameters are also used in the deployment.

Computing a relevance score between a user and an advertisement is based, at least partially, on the browsing context of the user and the nature of the advertisement. For example, if a user has been actively browsing content about new born babies, e.g., visiting and spending significant amounts of time reading web pages relating to diapering, layettes, baby clothes, feeding, infant formula, and so forth, advertisements relating to diapers, cribs, baby toys, baby bottles, infant car seats and such products should be considered to be relevant to the user's interests reflected by the user's browsing behavior. Likewise, if a user is visiting and spending a significant amount of time browsing web pages relating to golf, advertisements relating to driving ranges, specialty golf clubs, golf coaching, and such should be considered relevant to the interests of the user.

A computed U-A relevance scores is stored in the U-A relevance score archive 1585. In operation, to ensure efficiency, for each user, there may be only a realistic number of advertisements are considered to be relevant and this can be determined based on the U-A relevance scores. For that purpose, for each user, its relevance scores with respect to the advertisements can be ranked so that only a certain number of advertisements that have top ranking scores are considered to be relevant to the user. The relevance-based UARI generator 1580 generates the user-ad index 330 for every user in user database by linking each user with a specified (e.g., N) number of top ranking advertisements, determined based on their respective relevance scores (stored as top U-A configuration 1590).

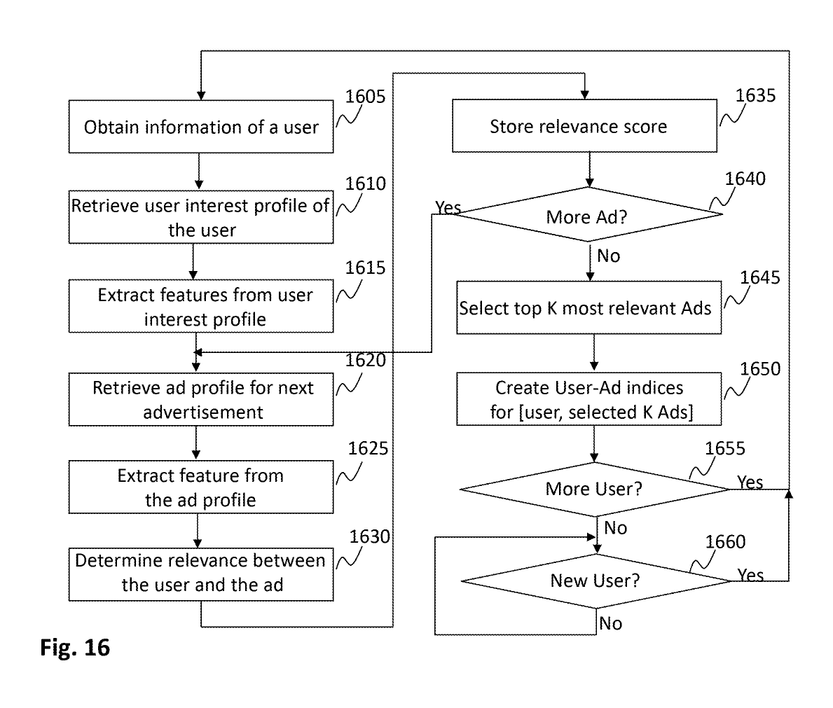

FIG. 16 is a flowchart of an exemplary process for generating user-ad index 330, according to an embodiment of the present teaching. At 1605, information about a user is obtained. Such information includes, e.g., the identity of the user. Based on the user's information, a user profile is retrieved at 1610. At 1615, features related to user's interests are identified from the user profile. With respect to this user, a relevance score is then computed against each advertisement in the advertisement database 155. At 1620, an advertisement profile for an advertisement is retrieved and features related to the advertisement are identified at 1625. At 1630, a U-A relevance score measuring the relevance between the user's interests and the advertisement is determined based on user features and advertisement features, At 1635, the U-A relevance score is stored. At 1640, the process checks if there are any additional advertisements (e.g., in advertisement database 155) for which the relevance with respect to the user has not been computed. If yes, the process goes back to 1620 to retrieve an advertisement profile for the next advertisement and continues till the relevance scores for all available advertisements are determined and stored.

Once relevance scores for all advertisements are determined (“No,” following 1640), top K most relevant advertisements are selected at 1645 based on their relevance scores with respect to the user. At 1650, user-ad index 330 is created for the particular user. At 1655, it is determined whether there are additional users. If so, the process returns to 1605 to start to process the next user. If the determination is no, the process waits till a new user comes available. If (or when) a new user is present, the process moves back to 1605 and proceeds to establish the user-ad index for the new user. One of ordinary skill in the art will recognize that while the flow chart in FIG. 16 shows a sequential process, user information may be processed in parallel to create user-ad index 330.

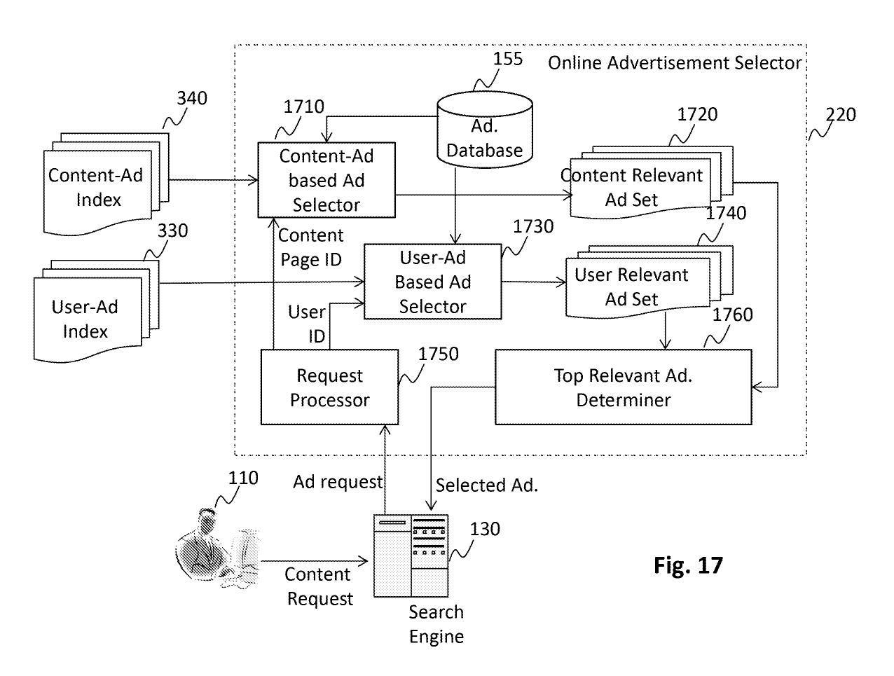

FIG. 17 depicts a high-level exemplary system diagram of the online advertisement selector 220, according to an embodiment of the present teaching. The online advertisement selector 220 is presented in FIG. 2, which utilizes the user-ad index 330 and content-ad index 340 to select a relevant advertisement to be inserted into a content page that is to be presented to a user. The online advertisement selector 220 comprises a request processor 1750 a user-ad based ad selector 1730, a content-ad based ad selector 1710, and a top relevant ad determiner 1760.

In operation, the request processor 1750 receives the request for an advertisement from, e.g., a search engine 130. The request may also be from a publisher or a content provider (not shown). The request provides information related to a user and a specific content page, which is to be presented to the user and is where the requested advertisement is to be incorporated into. Upon receiving the request, the request processor 1750 extracts information related to the user (e.g., user identifier) and information related to the content page (e.g., content page identifier) from the request. Using the content information, the content-ad based ad selector 1710 identifies a candidate ad set or content relevant advertisement set 1720 based on the content-ad index 340. For example, if the content page is associated with K top relevant advertisements, these advertisements form the content relevant ad set 1720. Similarly, the user-ad based ad selector 1730 identifies a user relevant ad set 1740 based on the user-ad index 330. For example, if the user is associated with N top relevant advertisements, these advertisements form the user relevant advertisement set 1740.

Based on the two candidate advertisement sets 1720 and 1740, the top relevant ad determiner 1760 determines a most relevant advertisement and sends the selected top advertisement in response to the request from the search engine 130. The top advertisement may be selected according to different selection criteria. For example, in some embodiments, an advertisement with a highest relevance score can be selected from the candidate advertisements from the content relevant ad set 1720 and user relevant ad set 1740. In some embodiments, the selected candidate advertisement may be required to be present in both the content relevant ad set 1720 and user relevant ad set 1740. In some embodiments, advertisements may be chosen based on their effective cost per thousand impressions (eCPM). Other metrics for choosing advertisements are contemplated.

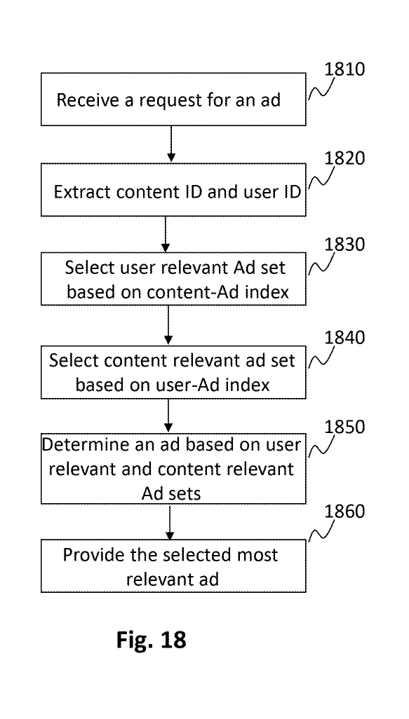

FIG. 18 is a flowchart of an exemplary process for selecting an advertisement most relevant to a given content page and a user, according to an embodiment of the present teaching. At 1810, a request for an advertisement is received. The request may be received from a search engine, a content provider, or any other entity. At 1820, a content identifier and a user identifier are obtained from the request. At 1830, a content relevant ad candidate set is determined based on the content-ad index 340 in accordance with the content identifier. At 1840, a user relevant ad candidate set is determined based on the user-ad index 330 in accordance with the user identifier. At 1850, a most relevant advertisement is selected from the content relevant ad set and the user relevant ad sets according to some criteria. At 1860, the selected most relevant advertisement is provided to the entity that requests the advertisement. One of ordinary skill in the art will recognize that while the flow chart in FIG. 18 depicts a sequential process, some of the steps e.g., selecting user relevant ad set and selecting content relevant ad set, may be performed in parallel.

Users' interactions with advertisements provided using the process described herein can be taken into account and fed back into the process to improve the relevance scores and ranking of the advertisements. Such a selected advertisement provides a higher degree of relevance in the context of a content web page and a user visiting the page. As such, this leads to improved reaction from a user to the displayed advertisement so that a content provider may potentially charge a premium rate for the impressions of advertisements while reducing user-aversion to visiting pages cluttered with irrelevant advertisements. This also helps the advertisers by selectively targeting users who would be most likely to purchase the product/service being marketed, thereby providing the most bang-for-the-buck for displaying the advertisements.

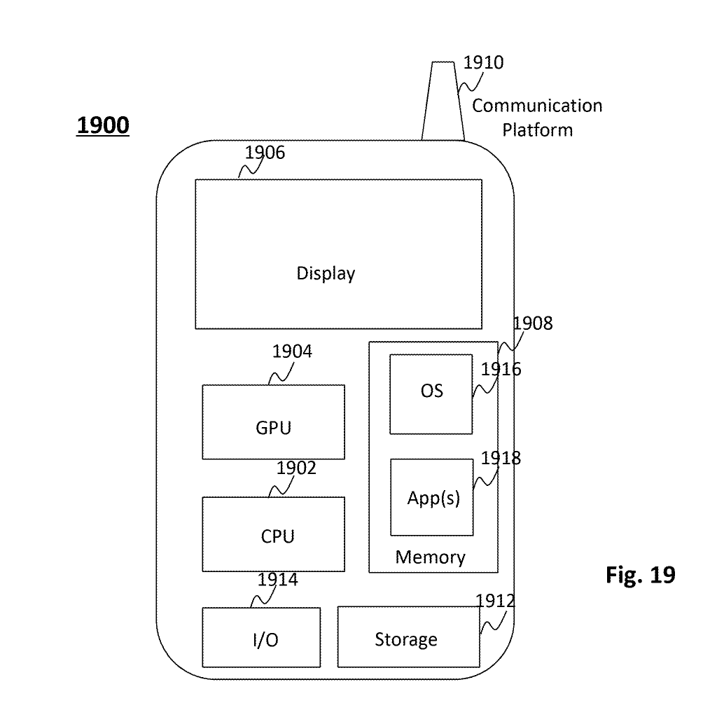

FIG. 19 depicts a general mobile device architecture of a mobile device 1900 on which the present teaching can be implemented. In this example, the mobile device 1900 includes a smart phone, a tablet, a music player, a handled gaming console, or a GPS receiver. The mobile device 1900 in this example includes one or more central processing units (CPUs) 1902, one or more graphic processing units (GPUs) 1904, a display 1906, a memory 1908, a communication platform 1910, such as a wireless communication module, storage 1912, and one or more input/output (I/O) devices 1914. Any other suitable component, such as but not limited to a system bus or a controller (not shown), may also be included in the mobile device 1900. As shown in FIG. 19, a mobile operating system 1916, e.g., iOS, Android, Windows Phone, etc., and one or more applications 1918 may be loaded into the memory 1908 from the storage 1912 in order to be executed by the CPU 1902. The applications 1918 may include a web browser or any other suitable mobile apps. Execution of the applications 1918 may cause the mobile device 1900 to perform some processing as described before. For example, the display of advertisement or other web content is made by the GPU 1904 in conjunction with the display 1906. User actions are received via the I/O devices 1914 and sent to remote servers via the communication platform 1910.

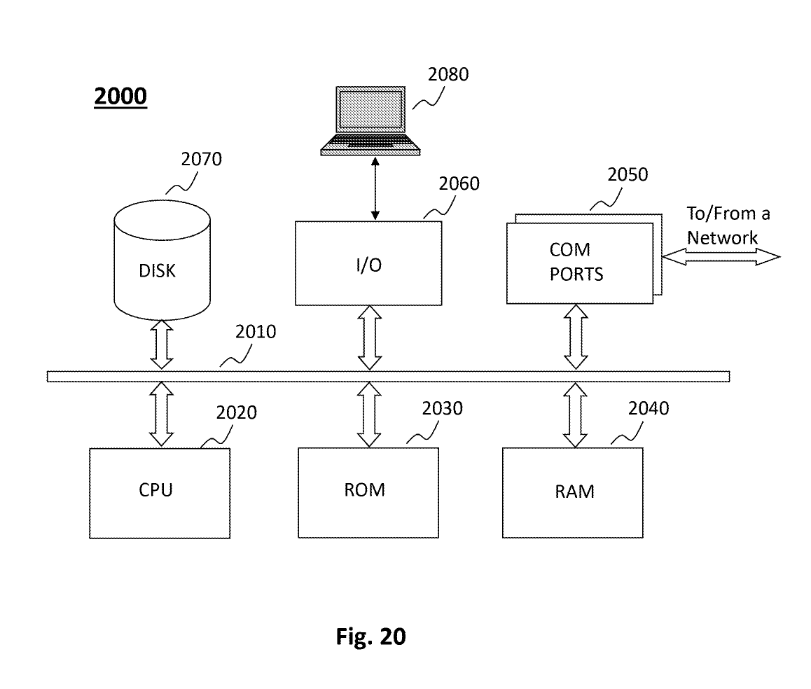

FIG. 20 depicts a general computer architecture on which the present teaching can be implemented and has a functional block diagram illustration of a computer hardware platform that includes user interface elements. The computer may be a general-purpose computer or a special purpose computer. The computer 2000 can be used to implement any components of the system for providing advertisements described herein. Different components of the system 140 of providing advertisements, e.g., as depicted in FIG. 2, can all be implemented on a computer such as computer 2000, via its hardware, software program, firmware, or a combination thereof. Although only one such computer is shown for convenience, the computer functions relating to selection of relevant advertisements may be implemented in a distributed fashion on a number of similar platforms to distribute the processing load.

Computer 2000, for example, includes COM ports 2050 connected to and from a network connected thereto to facilitate data communications. Computer 2000 also includes a central processing unit (CPU) 2020, in the form of one or more processors, for executing program instructions. The exemplary computer platform includes an internal communication bus 2010, program storage and data storage of different forms, e.g., disk 2070, read only memory (ROM) 2030, or random access memory (RAM) 2040, for various data files to be processed and/or communicated by the computer as well as possibly program instructions to be executed by the CPU. Computer 2000 also includes an I/O component 2060, supporting input/output flows between the computer and other components therein such as user interface elements 2080. Computer 2000 may also receive programming and data via network communications.

Hence, aspects of the method of providing advertisements as outlined above may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage of the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of content providers or other explanation generation service provider into the hardware platform(s) of a computing environment or other system implementing a computing environment or similar functionalities in connection with generating content and user relevant advertisements. Thus, another type of media that may bear the software elements include optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including by not limited to, a tangible storage medium, a carrier wave medium or physical transmission medium. Non-volatile storage media include, for example, optical or magnetic disks such as any of the storage devices in any computer(s) or the like, which may be used to implement the system or any of its components as shown in the drawings herein. Volatile storage media include dynamic memory, such as a main memory of such a computer platform. Tangible transmission media include coaxial cables, copper wires and fiber optics, including the wires that form a bus within a computer system. Carrier-wave transmission media can take the form of electric or electromagnetic signals, or acoustic or light waves such as those generated during radio frequency (RF) and infrared (IR) communications. Common forms of computer-readable media, therefore, include, for example, a floppy disk, a flexible disk, hard disk, magnetic tape, any other magnetic medium, a CD-ROM, DVD, any other optical medium, punch card paper tape, any other physical storage medium with patterns of holes, a RAM, a PROM, an EPROM, a FLASH EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for executing.

Those skilled in the art will recognize that the present teachings are amenable to a variety of modifications and/or enhancements. For example, although the implementation of various components described above may be embodied in a hardware device, it can also be implemented as a software only solution, e.g., an installation on an existing server. In addition, the multidimensional index and the indexing engine, and their components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method, implemented on a machine having at least one processor, storage, and a communication platform connected to a network for providing an advertisement, comprising the steps of:
receiving a request for an advertisement to be inserted into a content page to be presented to a user;
selecting an advertisement relevant to the content page and the user based on a content-advertisement index and a user-advertisement index, constructed based on user browsing context; and
transmitting information indicative of the selected advertisement as a response to the request.

2. The method of claim 1, wherein the step of selecting comprises:
identifying a first candidate advertisement set in accordance with the content-advertisement index based on a first identifier associated with the content page; and
identifying a second candidate advertisement set in accordance with the user-advertisement index based on a second identifier associated with the user; and
determining the selected advertisement based on the first and second candidate advertisement sets.

3. The method of claim 2, wherein the selected advertisement is determined based on whether it is present in both the first and second candidate advertisement sets.

4. The method of claim 1, wherein
the content-advertisement index includes at least one pair of a content identifier and an advertisement identifier, where each pair is associated with a first score indicative of relevance between a content page corresponding to the content identifier and an advertisement corresponding to the advertisement identifier; and
the user-advertisement index includes at least one pair of a user identifier and an advertisement identifier, where each pair is associated with a second score indicative of relevance between a user corresponding to the user identifier and an advertisement corresponding to the advertisement identifier.

5. A system having at least one processor, storage, and a communication platform connected to a network for providing an advertisement, comprising:
a multi-dimensional index constructor configured for establishing a content-advertisement index and a user-advertisement index based on browsing context associated with users; and
an online advertisement selector configured for selecting a relevant advertisement, based on the content-advertisement index and the user-advertisement index, in response to a request related to a content page into which the relevant advertisement is to be inserted and a user to whom the content page is to be presented.

6. The system of claim 5, wherein the multi-dimensional index constructor comprises:
a content-ad index generator configured for generating the content-advertisement index which includes at least one pair of a content identifier and an advertisement identifier, where each pair is associated with a first score indicative of relevant between a content page corresponding to a content identifier and an advertisement corresponding to an advertisement identifier in the content-advertisement index; and
a user-ad index generator configured for generating the user-advertisement index which includes at least one pair of a user identifier and an advertisement identifier, where each pair is associated with a second score indicative of relevant between a user corresponding to the user identifier and an advertisement corresponding to the advertisement identifier in the user-advertisement index.

7. The system of claim 5, wherein the online advertisement selector comprises:
a content-ad based advertisement selector configured for identifying a first candidate advertisement set based on the content-advertisement index in response to the request in accordance with a content identifier associated with the content page; and
a user-ad based advertisement selector configured for identifying a second candidate advertisement set based on the user-advertisement index in response to the request in accordance with a user identifier associated with the user, and
a relevant advertisement determiner configured for determining the relevant advertisement based on the first and second candidate advertisement sets.

8. A non-transitory machine-readable medium having information recorded thereon for providing an advertisement, wherein the information, when read by the machine, causes the machine to perform the following:
receiving a request for an advertisement to be inserted into a content page to be presented to a user;
selecting an advertisement relevant to the content page and the user based on a content-advertisement index and a user-advertisement index, constructed based on user browsing context; and
transmitting information indicative of the selected advertisement as a response to the request.

9. The medium of claim 8, wherein the step of selecting comprises:
identifying a first candidate advertisement set based on the content-advertisement index in accordance with a first identifier associated with the content page;
identifying a second candidate advertisement set based on the user-advertisement index in accordance with a second identifier associated with the user; and
determining the selected advertisement based on the first and second set of candidate advertisement sets.

10. The medium of claim 9, wherein
the content-advertisement index includes at least one pair of a content identifier and an advertisement identifier, where each pair is associated with a first score indicative of relevance between a content page corresponding to the content identifier and an advertisement corresponding to the advertisement identifier; and
the user-advertisement index includes at least one pair of a user identifier and an advertisement identifier, where each pair of content and user identifiers is associated with a second score indicative of relevance between a user corresponding to the user identifier and an advertisement corresponding to the advertisement identifier.

11. A method, implemented on a machine having at least one processor, storage, and a communication platform connected to a network for generating multi-dimensional index, comprising the steps of:
generating a content-advertisement index based on at least one content profile and at least one advertisement profile; and
generating a user-advertisement index based on at least one user profile and the at least one advertisement profile, wherein
the content-advertisement index and the user-advertisement index are used to select a relevant advertisement to be inserted in a content page that is presented to a user.

12. The method of claim 11, wherein
the content-advertisement index includes at least one pair of a content identifier and an advertisement identifier, where each pair is associated with a first score indicative of relevance between a content page corresponding to the content identifier and an advertisement corresponding to the advertisement identifier; and
the user-advertisement index includes at least one pair of a user identifier and an advertisement identifier, where each pair is associated with a second score indicative of relevance between a user corresponding to the user identifier and an advertisement corresponding to the advertisement identifier.

13. The method of claim 11, wherein
a user profile for a particular user is obtained based on information related to browsing context of the particular user;
a content profile for a content page is obtained based on information related to the content page; and
an advertisement profile for an advertisement is obtained based on information associated with the advertisement.

14. The method of claim 13, wherein the browsing context includes at least one of:
one or more features extracted from each content page that the particular user visited;
at least one tag of each content page that the particular user visited;
one or more actions taken by the particular user on each content page that the particular user visited; and
dwell time of the particular user spent on each content page that the particular user visited.

15. The method of claim 13, wherein the information related to the content page includes at least one of features of the content page, statistics related to the content page, and information on browsing context associated with the content page.

16. A non-transitory machine-readable medium having information recorded thereon for generating multi-dimensional index, wherein the information, when read by the machine, causes the machine to perform the following
generating a content-advertisement index based on at least one content profile and at least one advertisement profile; and
generating a user-advertisement index based on at least one user profile and the at least one advertisement profile, wherein
the content-advertisement index and the user-advertisement index are used to select a relevant advertisement to be inserted in a content page that is presented to a user.

17. The medium of claim 16, wherein
the content-advertisement index includes at least one pair of a content identifier and an advertisement identifier, where each pair is associated with a first score indicative of relevance between a content page corresponding to the content identifier and an advertisement corresponding to the advertisement identifier; and
the user-advertisement index includes at least one pair of a user identifier and an advertisement identifier, where each pair is associated with a second score indicative of relevance between a user corresponding to the user identifier and an advertisement corresponding to the advertisement identifier.

18. The medium of claim 16, wherein
a user profile for a particular user is obtained based on information related to browsing context of the particular user;
a content profile for a content page is obtained based on information related to the content page; and
an advertisement profile for an advertisement is obtained based on information associated with the advertisement.

19. The medium of claim 18, wherein the browsing context includes at least one of:
one or more features extracted from each content page that the particular user visited;
at least one tag of each content page that the particular user visited;
one or more actions taken by the particular user on each content page that the particular user visited; and
dwell time of the particular user spent on each content page that the particular user visited.

20. The medium of claim 18, wherein the information related to the content page includes at least one of features of the content page, statistics related to the content page, and information on browsing context associated with the content page.

21. A multi-dimension index generator, comprising:
a content-ad index generator configured for generating a content-advertisement index based on at least one content profile and at least one advertisement profile; and
a user-ad index generator configured for generating a user-advertisement index based on at least one user profile and the at least one advertisement profile, wherein
the content-advertisement index and the user-advertisement index are used to select a relevant advertisement to be inserted in a content page that is presented to a user.

22. The generator of claim 21, wherein the contend-ad index generator comprises:
a content feature identifier configured for obtaining a first feature set associated with a content page;
an ad feature identifier configured for obtaining a plurality of second feature sets, each of which is associated with an advertisement; and
a feature-based content-ad relevance identifier configured for identifying one or more advertisements that are relevant to the content page based on the first feature set and the plurality of second feature sets to create one or more pairs each of which includes a content identifier of the content page and an advertisement identifier, where each pair is associated with a first score indicative of relevance between the content page and an advertisement.

23. The generator of claim 21, wherein the user-ad index generator comprises:
a user feature identifier configured for obtaining a third feature set associated with a user;
an ad feature identifier configured for obtaining a plurality of second feature sets, each of which is associated with an advertisement; and
a feature-based user-ad relevance identifier configured for identifying one or more advertisements that are relevant to the user based on the third feature set and the plurality of second feature sets to create one or more pairs each of which includes a user identifier of the user and an advertisement identifier, where each pair is associated with a second score indicative of relevance between the user and an advertisement.

24. The generator of claim 21, further comprising:
an advertisement profile generator configured for obtaining an advertisement profile for an advertisement based on information associated with the advertisement;
a user profile generator configured for obtaining a user profile for a user based on information related to browsing context associated with the user, and
a content profile generator configured for obtaining a content profile based on information related to a content page.

25. The generator of claim 24, wherein the browsing context includes at least one of:
one or more features extracted from each content page that the particular user visited;
at least one tag of each content page that the particular user visited;
one or more actions taken by the particular user on each content page that the particular user visited; and
dwell time of the particular user spent on each content page that the particular user visited.

26. The method of claim 24, wherein the information related to the content page includes at least one of features of the content page, statistics related to the content page, and information on browsing context associated with the content page.
